(19) United States
(12) Patent Application Publication
(10) Pub. No.: US 2025/0258992 A1
(43) Pub. Date: Aug. 14, 2025

(54) Electronic Devices and Corresponding Methods for Utilizing User Sensory Preference Reaction Scores to Enhance User Interface Interactions

(71) Applicant: Motorola Mobility LLC, Chicago, IL (US)

(72) Inventors: Amit Kumar Agrawal, Bangalore (IN); Krishnan Raghavan, Bangalore (IN); Hariprasad Shanbhogue Alampady, Bangalore (IN)

(21) Appl. No.: 18/438,596

(22) Filed: Feb. 12, 2024

(51) Int. Cl. G06F 40/166; G06F 3/01

(52) U.S. Cl. CPC G06F 40/166; G06F 3/011

(57) ABSTRACT

An electronic device includes a user interface and one or more processors operable with the user interface. The one or more processors are configured to modify one or more user interface elements as a function of a dominant sensory profile associated with an authorized user of the electronic device to create a one or more modified user interface elements and, thereafter, cause the user interface to present the one or more modified user interface elements.

### BACKGROUND

### Technical Field

This disclosure relates generally to electronic devices, and more particularly to electronic devices having one or more sensors.

### Background Art

Portable electronic device usage has become ubiquitous. Vast majorities of the population carry a smartphone, tablet computer, or laptop computer daily to communicate with others, stay informed, to consume entertainment, and to manage their lives.

As the technology incorporated into these portable electronic devices has become more advanced, so too has their feature set. A modern smartphone includes more computing power than a desktop computer of only a few years ago. Additionally, while early generation portable electronic devices included physical keypads, most modern portable electronic devices include touch-sensitive displays. While such improvements to user interfaces are beneficial, each electronic device user is different from another. As such, a singular user interface may not be optimized for all users. It would be advantageous to have an improved electronic device with improved user interface capabilities so as to better fit the needs of all users.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory method in accordance with one or more embodiments of the disclosure.

FIG. 3 illustrates one or more method steps in accordance with one or more embodiments of the disclosure.

FIG. 4 illustrates another explanatory method in accordance with one or more embodiments of the disclosure.

FIGS. 5-10 illustrate different user interface presentations created as a function of dominant sensory profiles in accordance with one or more embodiments of the disclosure.

FIG. 11 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to identifying, by one or more sensors of an electronic device, a user using the electronic device, determining, with one or more processors of the electronic device, a dominant sensory profile associated with the user of the electronic device, modifying, by the one or more processors, one or more user interface elements configured for presentation on a user interface of the electronic device as a function of the dominant sensory profile associated with the user of the electronic device to create one or more modified user interface elements, and presenting, by the one or more processors on the user interface of the electronic device, the one or more modified user interface elements. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of modifying one or more user interface elements as a function of a dominant sensory profile associated with an authorized user of an electronic device to create one or more modified user interface elements and, thereafter, causing the user interface to present the one or more modified user interface elements as described herein. The non-processor circuits may include, but are not limited to, a radio receiver, a radio transmitter, signal drivers, clock circuits, power source circuits, and user input devices.

As such, these functions may be interpreted as steps of a method to perform the presentation, by one or more processors on a user interface, a plurality of user interface elements, with each user interface element of the plurality of user interface elements including components catering to a different sensory perception from other user interface elements of the plurality of user interface elements, measuring, using one or more sensors, reactions of a user of the electronic device to the plurality of user interface elements, determining, by the one or more processors, a user sensory preference reaction score, and, thereafter, modifying one or more other user interface elements configured for presentation on the user interface as a function of the user sensory preference reaction score to create one or more modified user interface elements and presenting the one or more modified user interface elements on a user interface of the electronic device. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Sensory branding is a concept sometimes used in marketing campaigns where marketing copy is designed to appeal to different—or all—senses in relation to a particular brand. Sensory branding uses the senses to relate to customers on an emotional level.

Some believe that the difference between products consumers consider to be “ordinary” suddenly become “captivating” products when the emotion of sensory branding is added. When such “emotion” is integrated into marketing copy, products and services seem to “shine” more to prospective customers. When this “emotion” is absent, potential customers can lack the enthusiasm and passion that is required to launch a product or service into the atmosphere of success.

Embodiments of the disclosure contemplate that owners of brands can forge emotional associations in the minds of potential customers by appealing to their senses. Indeed, a multi-sensory brand experience can beneficially generate certain beliefs, feelings, thoughts, and opinions to create a sensory image in the minds of those potential customers.

Embodiments of the disclosure also contemplate that the benefit of appealing to a person's senses can also be integrated into the user interface experiences provided by an electronic device. Said differently, embodiments of the disclosure contemplate that processors, sensors, and other components of an electronic device, such as a smartphone, can be configured to increase the pleasure, usage, excitement, and richness of the user interface experience. When user interfaces are configured to provide experiences in accordance with user sensory preference reaction scores or dominant sensory profiles configured in accordance with embodiments of the disclosure, users can even be prompted to recommend those user interfaces to others so that others can share in the joy of the rich sensory experiences.

Embodiments of the disclosure contemplate that sensory-focused experiences cater to the five senses of human beings, namely, sight, sound, touch, smell, and taste. Marketers and other companies are increasingly competing with each other to make their branding and advertising experiences sensory-focused. In multi-media environments, these companies increasingly use rich animations, music, and motion to appeal to users. While such user experiences can produce positive responses, they introduce to problematic issues: sensory overload/deprivation and lack of personalization.

While sensory branding can advantageously appeal to each of the senses of a user, embodiments of the disclosure contemplate that overloading one particular sense, or trying to stimulate all the senses at once, can lead to overstimulation. In turn, this overstimulation may result in the exact opposite of the effect desired, namely, less interest and engagement. To compensate, embodiments of the disclosure contemplate that certain brands present sensory overload experiences. However, this can lead to sensory deprivation leading to extremely low stimulation from the sensory branding. In short, users tend to get bored when there is no sensory value addition.

While companies frequently use sensory branding, the senses targeted by this branding reflects the company or brand and not the user. Illustrating by example, a coffee shop may create a user experience centered around aroma to appeal to a user's sense of smell. However, trying to appeal to this particular sense with each and every user may backfire when certain people are not “smell” centered when it comes to the five senses. Said differently, embodiments of the disclosure contemplate that sensory branding generally lacks personalization.

From these conclusions, it becomes evident that it would be advantageous to be able to personalize branding campaigns and corresponding user experiences to adapt to user preferences with particularity rather than delivering generic experiences. Embodiments of the disclosure contemplate that the stimulations that cater to different senses are not mutually exclusive. To the contrary, some users may enjoy having all five senses stimulated while other users may prefer only a few and may dislike more than that receiving stimulation. With prior art electronic devices and user interfaces, there is no way for companies and other content creators to understand how each individual user will react to sensory stimulation. Embodiments of the disclosure advantageously help such companies and content creators to know just this information so that they can target such users with specific user interface experiences that cater to their preferred sensory experiences.

In one or more embodiments, a method in an electronic device helps to identify the dominant sensory profile of each user of an electronic device. In one or more embodiments, the dominant sensory profile is associated with one or more senses that each user of the electronic device preferably responds.

In one or more embodiments, to determine the dominant sensory profile, one or more sensors of the electronic device monitor a user's interactions with the user interface of the electronic device and, optionally, also with any connected companion devices. The one or more sensors of the electronic device use a variety of parameters to determine, from detected reactions to a plurality of user interface elements presented on a user interface, a user sensory preference reaction score. In one or more embodiments, the user sensory preference reaction score defines a measurement of sensory responses for each sense of each user. In one or more embodiments, one or more processors can provide options for refining the user sensory preference reaction score as well. In one or more embodiments, the user sensory preference reaction scores are used to appropriately segment users into those that respond to, for example, visual stimuli, aural stimuli, smells, touch, and so forth.

In one or more embodiments, once the user sensory preference reaction score or dominant sensory profile is defined, a method in an electronic device comprises identifying, using one or more sensors of an electronic device, a user using the electronic device. The method then determines, using one or more processors of the electronic device, a dominant sensory profile associated with the user. In one or more embodiments, the one or more processors then modify one or more user interface elements configured for presentation on a user interface of the electronic device as a function of the dominant sensory profile to create one or more modified user interface elements. The one or more processors can then present, on the user interface of the electronic device, the one or more modified user interface elements.

In one or more embodiments, the modified user interface elements define the “touchpoints” that the user will utilize when interacting with the electronic device. While the modified user interface elements can take a number of forms, embodiments of the disclosure contemplate that they can generally be divided into four categories, namely, input controls, navigational components, informational components, and containers.

Input controls allow users to input information into the electronic device. Examples of input controls include radio buttons, toggles, check boxes, drop down lists, and so forth. Other examples of input controls will be obvious to those of ordinary skill in the art having the benefit of this disclosure.

Navigational components help users navigate a graphical user interface of an electronic device. Navigational components can include sliders, tags, search bars, breadcrumbs, and navigational styles. Other navigational components will be obvious to those of ordinary skill in the art having the benefit of this disclosure.

Informational components present and share information with users. Examples of informational components include tool tips that present a small text box that contains information about a certain feature of the system for example. Other examples of informational components will be obvious to those of ordinary skill in the art having the benefit of this disclosure.

Containers hold related content together. Examples include menu bars, application suites, tool bars, docks, and the like. Other examples of containers will be obvious to those of ordinary skill in the art having the benefit of this disclosure.

In one or more embodiments, when a user is identified by one or more sensors of an electronic device, one or more processors retrieve a user sensory preference reaction score from a user profile stored in a memory of the electronic device. The one or more processors can optionally present the user sensory preference reaction score on the user interface so that a user can deliver user input to adjust one or more sensory preference elements of the user sensory preference reaction score.

In one or more embodiments, an electronic device comprises a user interface and one or more processors operable with the user interface. In one or more embodiments, the one or more processors are configured to modify one or more user interface elements as a function of a dominant sensory profile associated with an authorized user of the electronic device to create one or more modified user interface elements and, thereafter, to cause the user interface to present the one or more modified user interface elements. Advantageously, embodiments of the disclosure allow a user interface of an electronic device to be personalized. Embodiments of the disclosure contemplate that this customization as a function of a user's dominant sensory profile is extremely useful in providing a rich, personalized experience that not only engages the user but that also motivates the user to continue using the electronic device.

In one or more embodiments, one or more processors of an electronic device adapt the user interface to each user's dominant sensory profile. This is in contrast to prior art electronic devices where user interfaces are static and uniform and are presented to all users regardless of which sensory perceptions each user tends to favor.

In one or more embodiments, one or more sensors of an electronic device determine that the electronic device is being used by an authorized user of the electronic device. One or more processors of the electronic device then determine a dominant sensory profile for the user by obtaining a user sensory preference reaction score that is calculated by monitoring responses to user interaction events catering to particular sensory perceptions in one or more embodiments. In other embodiments, the user sensory preference reaction score can be input using user settings and preference menus.

In one or more embodiments, the one or more processors modify user interface elements as a function of the dominant sensory profile or user sensory preference reaction score. This allows the one or more processors to configure different versions of a user interface comprising these user interface elements for each different user. Moreover, this personalizes different aspects of the user interface design such that input controls, navigational components, informational components, and containers are configured to cater to the preferred sensory perception of each user. In one or more embodiments, the one or more processors dynamically construct the user interface by dynamically blending each of the modified user interface elements to match the sensory preferences of each user. In one or more embodiments, when another user is detected using the electronic device, the process can repeat so that each user gets a rich, sensory customized user interface experience.

In one or more embodiments, the user sensory preference reaction score is determined using an ear-minded dominance score, an eye-minded dominance score, a smell-minded dominance score, a taste-minded dominance score, and a motor-minded dominance score. In one or more embodiments, each score can be multiplied by a weighting factor since not all scores are necessarily equal. Illustrating by example, a noise canceling headset factor may have a different weighting factor (higher or lower) compared to another factor associated with whether the user tends to enhance audio output with stereo, surround, or other effects.

Accordingly, in one or more embodiments a method in an electronic device comprises presenting, by one or more processors on a user interface, a plurality of user interface elements with each user interface element of the plurality of user interface elements including components catering to different sensory perceptions from other user interface elements of the plurality of user interface elements. One or more sensors can then measure reactions of a user of the electronic device to the plurality of user interface elements.

One or more processors can determine, from the reactions, a user sensory preference reaction score. Thereafter, the one or more processors can modify one or more other user interface elements configured for presentation on the user interface as a function of the user sensory preference reaction score to create one or more modified user interface elements The one or more processors can then cause the user interface to present these one or more modified user interface elements to provide the user with the desired rich, sensory customized user interface experience. The method can be repeated as different users use the electronic device.

In one or more embodiments, an electronic device comprises a user interface, a memory, one or more sensors, and one or more processors operable with the user interface, the memory, and the one or more sensors. In one or more embodiments, the one or more processors are configured to, when the one or more sensors identify an authorized user of the electronic device using the electronic device, to determine a dominant sensory profile associated with the authorized user and store the dominant sensory profile associated with the authorized user in the memory of the electronic device.

In one or more embodiments, the one or more processors are further configured to modify one or more user interface elements presented on the user interface of the electronic device as a function of the dominant sensory profile associated with the authorized user of the electronic device to create one or more modified user interface elements and, thereafter, cause the user interface to present the one or more modified user interaction events. In one or more embodiments, the one or more modified user interface elements are enhanced as a function of a first combination of a visual appearance preferred by the authorized user of the electronic device, an olfactory appearance preferred by the authorized user of the electronic device, an aural appearance preferred by the authorized user of the electronic device, a gustatory appearance preferred by the authorized user of the electronic device, and a haptic appearance preferred by the authorized user of the electronic device and diminished as a second combination of the visual appearance preferred by the authorized user of the electronic device, the olfactory appearance preferred by the authorized user of the electronic device, the aural appearance preferred by the authorized user of the electronic device, the gustatory appearance preferred by the authorized user of the electronic device, and the haptic appearance preferred by the authorized user of the electronic device.

Advantageously, embodiments of the disclosure identify and provide assessments of the most receptive dominant sensors as a function of monitoring device usage behavior. Thereafter, components of user interface presentations can be modified as a function of this dominant sensory profile. Other advantages will be described below. Still others will be obvious to those of ordinary skill in the art having the benefit of this disclosure.

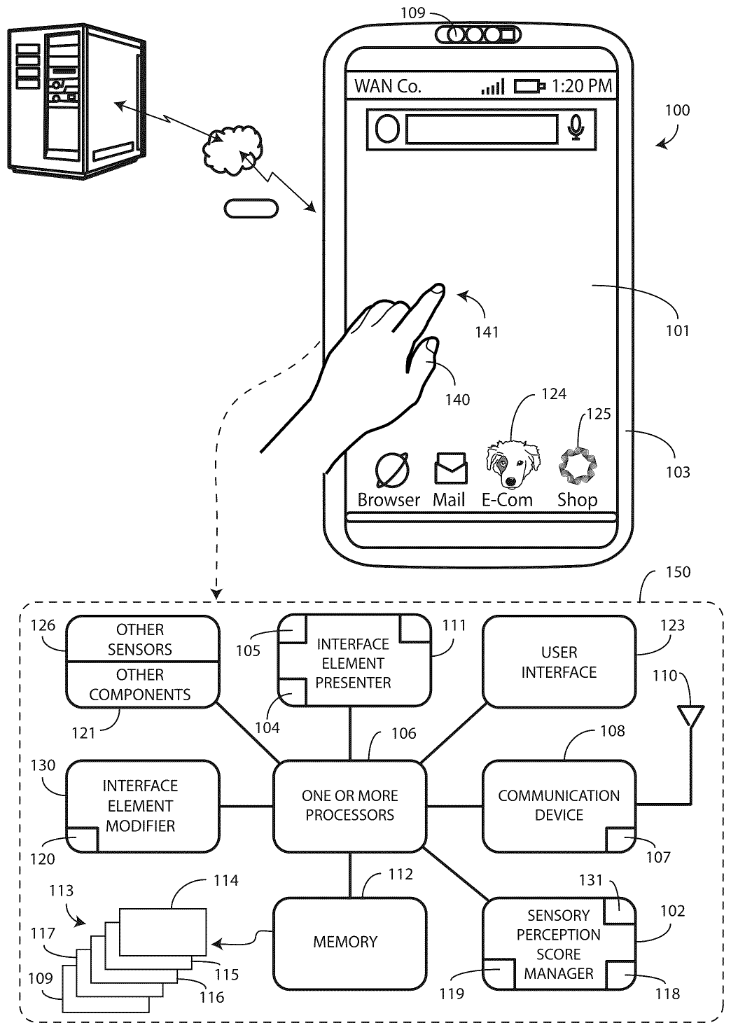

Turning now to FIG. 1, illustrated therein is one electronic device 100 configured in accordance with one or more embodiments of the disclosure. The electronic device 100 of this illustrative embodiment includes a user interface 123. In one or more embodiments, the user interface 123 comprises a display 101, which may optionally be touch-sensitive. The display 101 can serve as a primary user interface 123 of the electronic device 100.

Where the display 101 is touch sensitive, users can deliver user input to the display 101 by delivering touch input from a finger, stylus, or other objects disposed proximately with the display. In one embodiment, the display 101 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 1 includes a housing 103. Features can be incorporated into the housing 103. Examples of features that can be included along the housing 103 include an imager 109, shown as a camera in FIG. 1, or an optional speaker port. A user interface component, which may be a button or touch sensitive surface, can also be disposed along the housing 103.

A block diagram schematic 150 of the electronic device 100 is also shown in FIG. 1. In one embodiment, the electronic device 100 includes one or more processors 106. In one embodiment, the one or more processors 106 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 112, can optionally store the executable software code used by the one or more processors 106 during operation.

In this illustrative embodiment, the electronic device 100 also includes a communication device 108 that can be configured for wired or wireless communication with one or more other devices or networks. The networks can include a wide area network, a local area network, and/or personal area network. The communication device 108 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 108 can include wireless communication circuitry, one of a receiver, a transmitter, or transceiver, and one or more antennas 110.

The electronic device 100 can optionally include a near field communication circuitry 107 used to exchange data, power, and electrical signals between the electronic device 100 and another electronic device. In one embodiment, the near field communication circuitry 107 is operable with a wireless near field communication transceiver, which is a form of radio-frequency device configured to send and receive radio-frequency data to and from the companion electronic device or other near field communication objects.

Where included, the near field communication circuitry 107 can have its own near field communication circuit controller in one or more embodiments to wirelessly communicate with companion electronic devices using various near field communication technologies and protocols. The near field communication circuitry 107 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 106 can be responsible for performing the primary functions of the electronic device 100. For example, in one embodiment the one or more processors 106 comprise one or more circuits operable to present presentation information, such as images, text, and video, on the display 101. In one or more embodiments, this information can be specifically tailored to a user sensory preference reaction score 118 and/or a dominant sensory profile 119 associated with an authorized user of the electronic device 100.

Illustrating by example, in one or more embodiments a sensory perception score manager 102 is operable to present, on the user interface 123, a plurality of user interface elements 131. In one or more embodiments, each of the plurality of user interface elements 131 includes components catering to different sensory perceptions from other user interaction events of the plurality of user interface elements 131.

For instance, in one or more embodiments the plurality of user interface elements 131 comprises text, with at least one user interface element enhancing a characteristic associated with at least one user sensory element and diminishing another characteristic associated with at least one other user sensory element. If a basic user sensory element was an advertisement for fried chicken from Buster's Chicken Shack, when that user sensory element was configured to enhance a sight characteristic, touch characteristic, and sound characteristic, while diminishing a smell characteristic and taste, the advertisement may read “See Buster's Chicken Glisten as the beautifully crisped crust crackles in your fingers.” By contrast, if the user sensory element was configured to enhance taste and smell, while diminishing sight, touch, and sound, the advertisement may read, “Blind tasters instantly recognize that heavenly aroma, even before the succulent juices reach their lips,” and so forth.

Accordingly, by presenting this plurality of user interface elements 131 and measuring reactions, the sensory perception score manager 102 can not only calculate the user sensory preference reaction score 118 of the authorized user of the electronic device 100, but also associate that user sensory preference reaction score 118 with a dominant sensory profile 119 associated with the authorized user of the electronic device 100. The sensory perception score manager 102 can then store the dominant sensory profile 119 in the memory 112 of the electronic device 100.

When new users begin using the electronic device 100, the sensory perception score manager 102 can detect, using the one or more sensors 126, another user using the electronic device 100. In one or more embodiments, the sensory perception score manager 102 then repeats the presentation of the plurality of user interface elements 131, measures the reactions of the other user to the plurality of user interface elements 131, and determines from those reactions another user sensory preference reaction score 118. Thus, multiple users can each have a personalized user sensory preference reaction score 118 and corresponding dominant sensory profile 119.

In one or more embodiments, the sensory perception score manager 102 then measures, using one or more sensors 126 of the electronic device 100, reactions of a user of the electronic device 100 to the plurality of user interface elements 131. In one or more embodiments, the sensory perception score manager 102 then determines a user sensory preference reaction score 118 from the reactions to the plurality of user interface elements 131. Moreover, when the one or more sensors 126 identify an authorized user of the electronic device 100 using the electronic device 100, the sensory perception score manager 102 can determine a dominant sensory profile 119 associated with the authorized user. The dominant sensory profile 119 can be stored in the sensory perception score manager 102, in the memory 112, or elsewhere.

Thereafter, an interface element modifier 130 can modify one or more other user interface elements 120 as a function of the dominant sensory profile 119 associated with the authorized user of the electronic device 100 to create one or more modified user interface elements 104. An interface element presenter 111 can then cause the user interface 123 to present the one or more modified user interface elements 104.

As noted above, the one or more modified user interface elements 104 can take a variety of forms, many of which can be segmented into the four groups that include input controls, navigational components, informational components, and containers. To illustrate how the interface element modifier 130 can modify the one or more other user interface elements 120 to create the one or more modified user interface elements 104, consider the situation where the one or more modified user interface elements 104 comprise informational components in the form of an advertisement for a clothing brand.

When the dominant sensory profile 119 indicates that a user is visually dominant, the copy of the advertisement may read, “See yourself in a new light with our fashion forward designs that ignite your inner style icon.” By contrast, when the dominant sensory profile 119 indicates that a user is aurally dominant, the copy may read, “Listen to the rhythm of fashion as our fabrics whisper tales of elegance and self-expression.”

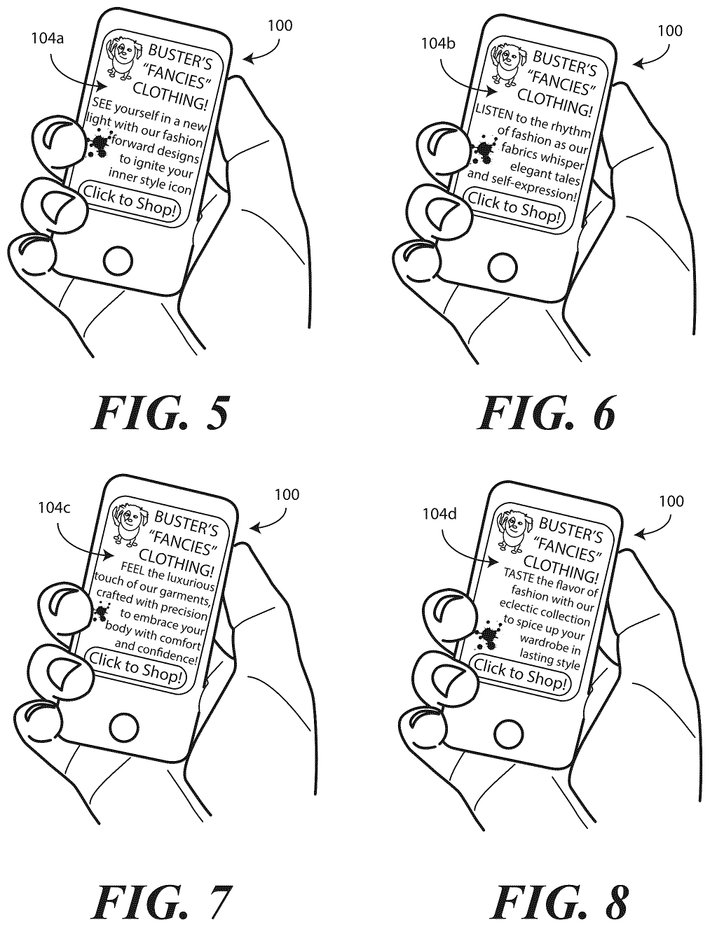

If the dominant sensory profile 119 indicates that the user is touch-dominant, the copy may read, “Feel the luxurious touch of our garments, crafted with precision to embrace your body with comfort and confidence.” If the dominant sensory profile 119 indicates that the user is taste-dominant, the copy might read, “Taste the flavor of fashion with our eclectic collection that spices up your wardrobe and leaves a lasting impression.” If the dominant sensory profile 119 indicates that the user is olfactory-dominant, the copy may read, “Breath in the essence of fashion with our clothing that exudes a captivating scent of sophistication and allure,” and so forth. Other examples of one or more modified user interface elements 104 will be described and illustrated below with reference to FIGS. 5-10. Still others will be obvious to those of ordinary skill in the art having the benefit of this disclosure.

If the one or more modified user interface elements 104 are wallpaper, for the motor-minded the wallpaper may include a spiral or other image that connotes motion. For the taste-minded, the wallpaper may include a picture of a plate, knife, and fork. For the smell-minded, the wallpaper may present a picture of a perfume bottle, and so forth.

Where the one or more modified user interface elements 104 comprise user input controls, for the motor-minded, input operations can include the movement of user actuation targets on the display. Such users may also receive haptic feedback in response to user input. By contrast, for the visually minded, the user input controls may comprise colors and rich images, and so forth.

If the one or more modified user interface elements 104 comprise user interface transitions, for the motor-minded there can be swift transitions. By contrast, for those users that are not motor-minded, the user interface may avoid transitions all together. For the aurally-minded, the end of a user input may be signaled with short auditory tones, and so forth.

Where the one or more modified user interface elements 104 are taste-minded, the color of the one or more modified user interface elements 104 may be tailored to invoke the gustatory senses. Where users have high user sensory preference reaction scores for multiple senses, the one or more modified user interface elements 104 may cater to those senses for which the user has high user sensory preference reaction scores and diminish elements catering to other senses for which the user has low user sensory preference reaction scores. Illustrating by example, a user interface may employ a lot of motion and color for a user that is both motor-minded and eye-minded.

In one or more embodiments, one or more sensors 126 of the electronic device identify a user using the electronic device 100. One or more processors 106 of the electronic device 100 determine a dominant sensory profile 119 associated with the user, such as one stored in a user profile 105 of the electronic device 100. Illustrating by example, in one or more embodiments the one or more processors 106 determine the dominant sensory profile 119 of the user of the electronic device 100 by retrieving a user sensory preference reaction score 118 from a memory 112 of the electronic device 100.

The interface element modifier 130 can the modify one or more user interface elements 120 configured for presentation on the user interface 123 as a function of the dominant sensory profile 119 to create one or more modified user interface elements 104. The interface element presenter 111 can then present the one or more modified user interface elements 104 on the user interface 123. In one or more embodiments, the presenting the one or more modified user interface elements 104 occurs only so long as the user continues to use the electronic device 100. When another user uses the electronic device 100, the process can repeat such that the one or more modified user interface elements 104 cater to a different user sensory preference reaction score of the new user.

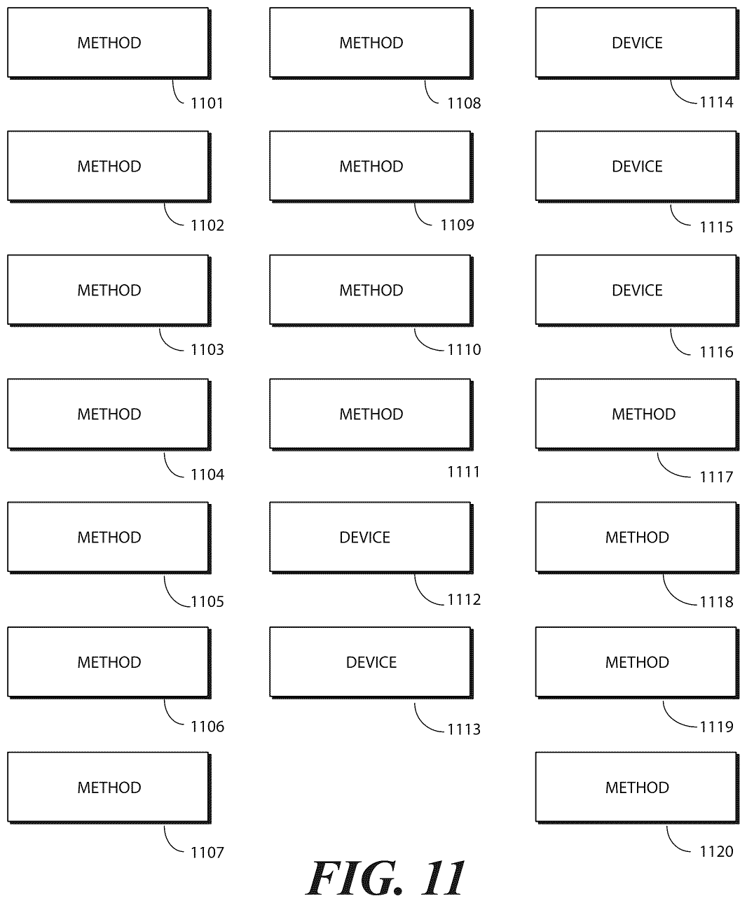

In still other embodiments, the interface element modifier 130 is configured to modify the one or more modified user interface elements 104 to create other modified user interface elements in response to user input received by the user interface 123 modifying the dominant sensory profile 119 associated the user of the electronic device 100. An example of how this can occur will be described below with reference to FIG. 10.

In one or more embodiments, the one or more modified user interface elements 104 are enhanced as a function of a first combination of a visual appearance preferred by the authorized user of the electronic device 100, an olfactory appearance preferred by the authorized user of the electronic device 100, an aural appearance preferred by the authorized user of the electronic device 100, a gustatory appearance preferred by the authorized user of the electronic device 100, and a haptic appearance preferred by the authorized user of the electronic device 100 and diminished as a second combination of the visual appearance preferred by the authorized user of the electronic device 100, the olfactory appearance preferred by the authorized user of the electronic device 100, the aural appearance preferred by the authorized user of the electronic device 100, the gustatory appearance preferred by the authorized user of the electronic device 100, and the haptic appearance preferred by the authorized user of the electronic device 100. In one or more embodiments, the one or more modified user interface elements 104 comprise text that is different from the one or more user interface elements.

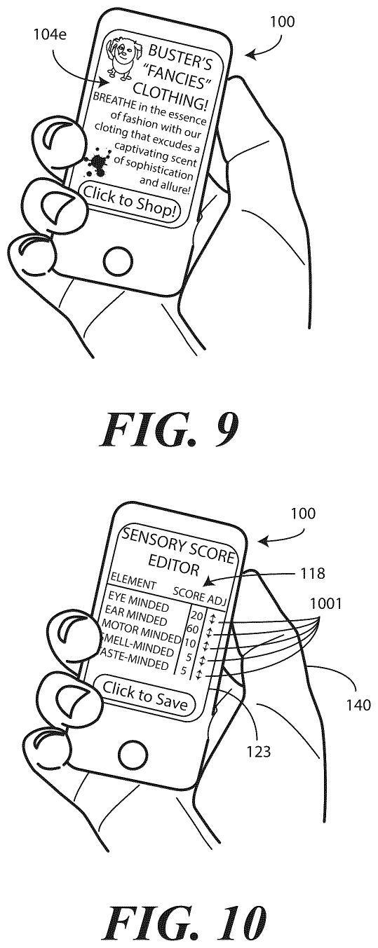

To even further illustrate by example, turn now to FIGS. 5-9. Illustrated in each figure is the electronic device 100 presenting a modified user interface element. In FIG. 5, a first modified user interface element 104a is being presented, while in FIG. 6 a second modified user interface element 104b is being presented. In FIG. 7, a third modified user interface element 104c is being presented, while a fourth user interface element 104d is being presented in FIG. 8. In FIG. 9, a fifth modified user interface element 104e is being presented.

Each modified user interface element 104a,104b,104c,104d,104e is an advertisement for Buter's Fancies Clothing. However, as noted above in other embodiments the modified user interface elements 104a,104b,104c,104d,104e can take other forms.

Illustrating by example, in one or more embodiments the modified user interface elements 104a,104b,104c,104d,104e comprise user input controls. In other embodiments, the modified user interface elements 104a,104b,104c,104d, 104e comprise navigational elements. In still other embodiments, the modified user interface elements 104a,104b,104c,104d,104e comprise containers. Of course, these explanatory examples of modified user interface elements 104a,104b,104c,104d,104e can be used in various combinations, with multiple modified user interface elements 104a,104b,104c,104d,104e being presented on a user interface of the electronic device 100. Moreover, other examples of modified user interface elements 104a,104b,104c,104d,104e will be obvious to those of ordinary skill in the art having the benefit of this disclosure.

In this illustrative example, each modified user interface element 104a,104b,104c,104d,104e comprises text that is different from each other modified user interface element 104a,104b,104c,104d,104e. Importantly, the text results in each modified user interface element 104a,104b,104c,104d,104e catering to a particular sense, and enhancing a characteristic associated with at least one user sensory element and diminishing another characteristic associated with at least one other user sensory element.

The modified user interface element 104a of FIG. 5 caters to sight, asking the user to “SEE yourself in a new light,” which caters to a sight-based user sensory element. By contrast, the modified user interface element 104b of FIG. 6 asks the user to “LISTEN to the rhythm” of fashion as Buster's fabrics “whisper” elegant tales, thereby catering to an ear-based user sensory element.

The modified user interface element 104c of FIG. 7 caters to touch, asking the user to “FEEL the luxurious touch” of the garments that “embrace your body.” These descriptors or touch cater to a touch-based user sensory element. By contrast, the modified user interface element 104d of FIG. 8 asks the user to “TASTE the flavor of fashion” as Buster's fabrics “spice up” your wardrobe, thereby catering to an ear-based user sensory element.

In FIG. 9, the modified user interface element 104e asks the user to “BREATHE in” the essence of fashion by choosing clothing that “exudes a captivating scent” of sophistication and allure, thereby catering to a smell-based user sensory element. These examples are illustrative only, as numerous others will be obvious to those of ordinary skill in the art having the benefit of this disclosure. While single sensory preference elements are highlighted in the modified user interface elements 104a,104b,104c,104d,104e are shown in FIGS. 5-9 for ease of illustration, in other embodiments, and indeed in most embodiments, the sensory preference elements found in each of the one or more modified user interface elements 104a,104b,104c,104d,104e will comprise a plurality of user sensory preference elements.

Turning now back to FIG. 1, in one or more embodiments, the user sensory preference reaction score 118 is determined using a combination of scores corresponding to each of the senses. Illustrating by example, in one or more embodiments the user sensory preference reaction score 118 is determined using an eye-minded dominance score, a smell-minded dominance score, an ear-minded dominance score, a taste-minded dominance score, and a motor-minded dominance score. In one or more embodiments, the sensory perception score manager 102 normalizes the eye-minded dominance score, the smell-minded dominance score, the ear-minded dominance score, the taste-minded dominance score, and the motor-minded dominance score so that each heat spreader a value between one and negative one, inclusive.

In one or more embodiments, the sensory perception score manager 102 allows a user 140 to adjust the user sensory preference reaction score 118 by delivering user input 141 to the user interface 123. Illustrating by example, in one or more embodiments the sensory perception score manager 102 can present the user sensory preference reaction score 118 on the user interface 123. The user interface 123 can then receive user input 141 in response to this presentation. The sensory perception score manager 102 can then adjust one or more sensory element preference elements of the user sensory preference reaction score 118 as a function of the user input 141.

Turning briefly to FIG. 10, illustrated therein is the electronic device 100 presenting the user sensory preference reaction score 118 on the user interface 123. In this illustrative embodiment, the user sensory preference reaction score 118 has been broken down into sensory preference elements, namely, the eye-minded dominance score, the ear-minded dominance score, the motor-minded dominance score, the smell-minded dominance score, and the taste-minded dominance score so that the user 140 can see each individual score. By delivering user input (141) to adjustment user actuation targets 1001, the user 140 can adjust the one or more sensory preference elements so that the user sensory preference reaction score 118 is changed as a function of the user input.

Turning now back to FIG. 1, in one or more embodiments the interface element modifier 130 can modify the one or more user interface elements 120 configured for presentation on the user interface 123 of the electronic device 100 as a function of a dominant sensory profile 119 associated with the user 140 of the electronic device 100 to create one or more modified user interface element 104. Thereafter, the interface element presenter 111 can present the one or more modified user interface elements 104 on the user interface 123, as was illustrated above in FIGS. 7-11. When the one or more user interface elements 120 configured for presentation on the user interface 123 of the electronic device 100 comprise informational components comprising text, as was the case in FIGS. 5-9, the interface element modifier 130 can change the text to enhance a characteristic associated with at least one user sensory preference element and diminish another characteristic associated with at least one other user sensory preference element.

The executable software code used by the one or more processors 106 can be configured as one or more modules 113 that are operable with the one or more processors 106. Such modules 113 can store instructions, control algorithms, and so forth.

In one or more embodiments, these modules 113 identify high dominance and low dominance factors for each sense. In one or more embodiments, the sensory perception score manager 102 then, for each factor, calculates a score based upon user behavior. For instance, if a user always wears a noise canceling headset, even when that headset is not being used to deliver audio to the user, the sensory perception score manager 102 might calculate a low score for the ear-minded dominance score.

In one or more embodiments, the sensory perception score manager 102 considers weights. For instance, the sensory perception score manager 102 may multiply each of the eye-minded dominance score, the smell-minded dominance score, the ear-minded dominance score, the taste-minded dominance score, and the motor-minded dominance score by a weight since not all factors are the same. To illustrate by example, wearing a noise canceling headset may carry more weight in an ear-minded dominance score than does the fact that the user 140 actuates enhanced stereo sound from an audio output device of the other components 121.

Once this is complete, the sensory perception score manager 102 can sum all the scores to determine the user sensory preference reaction score 118. In one or more embodiments, the sensory perception score manager 102 normalizes the user sensory preference reaction score 118 to a value of between negative one and positive one to ensure scores can be compared against senses.

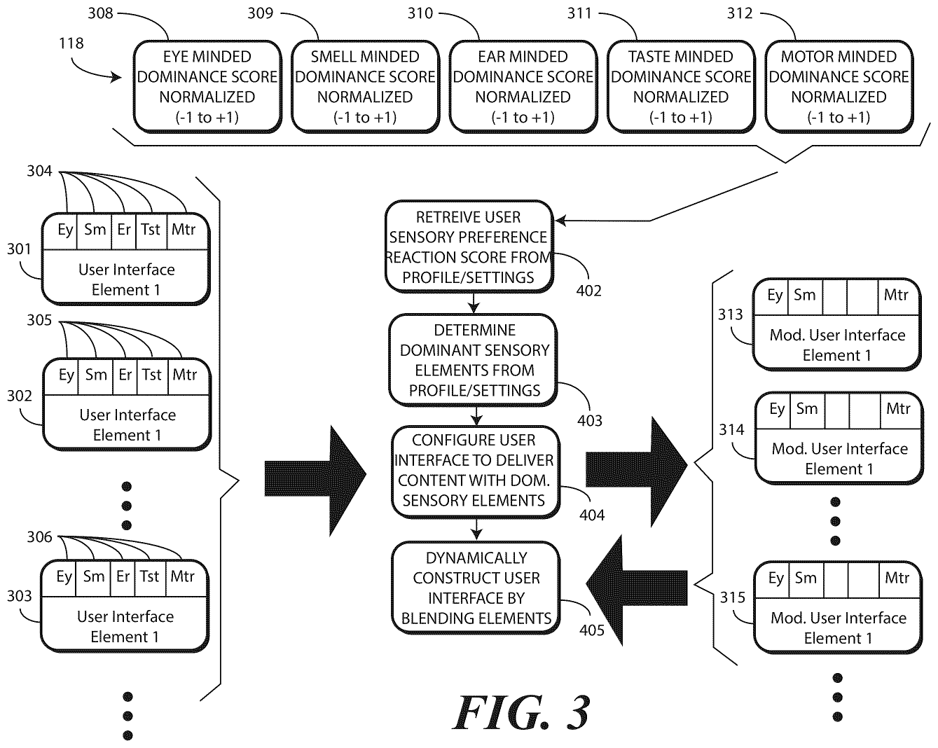

To graphically illustrate how the user sensory preference reaction score 118 can be determined, turn briefly to FIG. 3. In one or more embodiments, the user sensory preference reaction score 118 is determined using an eye-minded dominance score 308, a smell-minded dominance score 309, an ear-minded dominance score 310, a taste-minded dominance score 311, and a motor-minded dominance score 312. In one or more embodiments, each of the eye-minded dominance score 308, smell-minded dominance score 309, ear-minded dominance score 310, taste-minded dominance score 311, and motor-minded dominance score 312 can be normalized to have a value between one and negative one, inclusive.

In one or more embodiments, each of the eye-minded dominance score 308, smell-minded dominance score 309, ear-minded dominance score 310, taste-minded dominance score 311, and motor-minded dominance score 312 is comprised of different factors, with some having higher weights than others. Illustrating by example, some “higher factors” for the eye-minded dominance score 308, the ear-minded dominance score 310, and the motor-minded dominance score 312, as well as some “lower factors” for the eye-minded dominance score 308, the ear-minded dominance score 310, and the motor-minded dominance score 312 can be used. As noted above, in many cases these factors can be weighted since not all factors are considered the same.

Examples of higher factors for the eye-minded dominance score 308 include high usage of video applications, actively changing wall papers and screen saver images, heavy use of high-definition and 4K resolution, and using hue lights on connected companion devices. These higher factors tend to demonstrate that the dominant sensory profile (119) caters to visual sensory perception. By contrast, lower factors for the eye-minded dominance score 308 include actively lowering the brightness of the display, turning on a “dark only” color scheme, and failing to direct their gaze toward the display even when videos are playing. These lower factors tend to demonstrate that the dominant sensory profile (119) diminishes the importance of visual sensory perception.

Turning to the ear-minded dominance score 310, the higher factors indicating that the dominant sensory profile (119) cates to aural sensory perception include the user continually turning on audio enhancement features such as Dolby.sup.™ ATMOS.sup.™, the usage of high-end audio companion electronic devices, the use of noise canceling headsets, large consumption of audio content, and continually playing music on home companion electronic devices. Lower factors demonstrating that the dominant sensory profile (119) diminishes the importance of aural sensory perception include the fact that the volume setting is continually turned down, the fact that headsets or earbuds are almost never, or never, connected to the electronic device, the fact that a user wears a noise-canceling headset with no audio output, and the fact that a user plays games without any audio output.

Turning to the motor-minded dominance score 312, higher factors demonstrating that the dominant sensory profile (119) indicates that a person is touch motivated include having haptic features turned ON so that the devices buzzes and vibrates, the fact that “live” wallpapers are selected, the fact that the user continually fidgets with the electronic device, either spinning a candy bar device, continually opening and closing a hinged electronic device having a first device housing that is pivotable relative to a second device housing between an axially displaced open position and a closed position, or continually moving a slidable display, the fact that the user enjoys virtual reality applications and companion electronic devices, the fact that the user interacts with videos and images or actively seeks the consumption of video content, and the fact that the user continually uses the device while traveling. Lower factors indicating that the dominant sensory profile (119) is not sensitive to touch include the fact that the user has turned off all haptic devices or is not into gaming.

The examples of factors for three of the five minded dominance scores are illustrative only and are intended to provide information concerning how each of the eye-minded dominance score 308, smell-minded dominance score (309), ear-minded dominance score 310, taste-minded dominance score (311), and motor-minded dominance score 312 can be calculated. Numerous others will be obvious to those of ordinary skill in the art having the benefit of this disclosure.

Turning now back to FIG. 1, in one or more embodiments the one or more processors 106 are responsible for running the operating system environment 114. The operating system environment 114 can include a kernel, one or more drivers, and an application service layer 115, and an application layer 116. The operating system environment 114 can be configured as executable code operating on one or more processors or control circuits of the electronic device 100.

The application service layer 115 can be responsible for executing application service modules. The application service modules may support one or more applications 117 or “apps.” Examples of such applications include a cellular telephone application for making voice telephone calls, a web browsing application configured to allow the user to view webpages on the display 101 of the electronic device 100, an electronic mail application configured to send and receive electronic mail, a photo application configured to organize, manage, and present photographs on the display 101 of the electronic device 100, and a camera application for capturing images with the imager 109. Collectively, these applications constitute an “application suite.” In one or more embodiments, these applications comprise one or more e-commerce applications 124 and/or shopping applications 125 that allow electronic commerce orders to be placed and financial transactions to be made using the electronic device 100. In one or more embodiments, the one or more e-commerce applications 124 and/or shopping applications 125 can be responsible for generating the one or more user interface elements 120 that are modified by the interface element modifier 130.

In one or more embodiments, the one or more processors 106 are responsible for managing the applications and all personal information received from the user interface 123 that is to be used by the e-commerce application 124 and/or electronic shopping application 125 after the electronic device 100 is authenticated as a secure electronic device and the user identification credentials have triggered an electronic payment transaction request to complete an electronic shopping cart interaction event. The one or more processors 106 can also be responsible for launching, monitoring, and killing the various applications and the various application service modules. In one or more embodiments, the one or more processors 106 are operable to not only kill the applications, but also to expunge any and all personal data, data, files, settings, or other configuration tools when the electronic device 100 is reported stolen or when the e-commerce application 124 and/or electronic shopping application 125 are used with fraudulent activity to wipe the memory 112 clean of any personal data, preferences, or settings of the person previously using the electronic device 100.

The one or more processors 106 can also be operable with other components 121. The other components 121, in one embodiment, include input components, which can include acoustic detectors as one or more microphones. The one or more processors 106 may process information from the other components 121 alone or in combination with other data, such as the information stored in the memory 112 or information received from the user interface.

The other components 121 can include a video input component such as an optical sensor, another audio input component such as a second microphone, and a mechanical input component such as button. The other components 121 can include one or more sensors 126, which may include key selection sensors, touch pad sensors, capacitive sensors, motion sensors, and switches. Similarly, the other components 121 can include video, audio, and/or mechanical outputs.

The one or more sensors 126 may include, but are not limited to, accelerometers, touch sensors, surface/housing capacitive sensors, audio sensors, and video sensors. Touch sensors may be used to indicate whether the electronic device 100 is being touched at side edges. The other components 121 of the electronic device can also include a device interface to provide a direct connection to auxiliary components or accessories for additional or enhanced functionality and a power source, such as a portable battery, for providing power to the other internal components and allow portability of the electronic device 100.

In one or more embodiments, each of the sensory perception score manager 102, the interface element modifier 130, and the interface element presenter 111 can be operable with one or more processors 106, configured as a component of the one or more processors 106, or configured as one or more executable code modules operating on the one or more processors 106. In other embodiments, the sensory perception score manager 102, the interface element modifier 130, and the interface element presenter 111 can be standalone hardware components operating executable code or firmware to perform their functions. Other configurations for the sensory perception score manager 102, the interface element modifier 130, and the interface element presenter 111 will be obvious to those of ordinary skill in the art having the benefit of this disclosure.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components, and still be within the scope of the present disclosure.

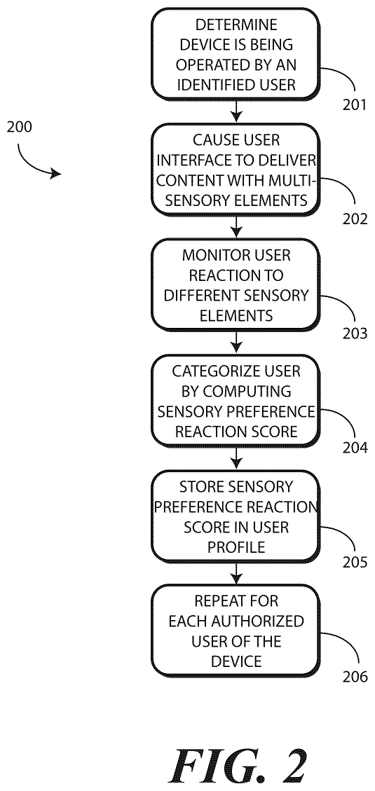

Turning now to FIG. 2, illustrated therein is one explanatory method 200 in accordance with one or more embodiments of the disclosure. The method 200 is suitable, for example, to operate in the electronic device (100) of FIG. 1. In other embodiments, the method 200 could be implemented by the cloud server shown in communication with the electronic device (100) of FIG. 1 across a network. Other configurations for executing the method 200 of FIG. 2 will be obvious to those of ordinary skill in the art having the benefit of this disclosure.

Beginning at step 201, one or more sensors of an electronic device identify an authorized user of the electronic device using the electronic device. At step 202, one or more processors of the electronic device present, on a user interface, a plurality of user interface elements. In one or more embodiments, each user interface element of the plurality of user interface elements includes components catering to a different sensory perception from other user interface elements of the plurality of user interface elements.

At step 203, the method 200 measures, using one or more sensors, reactions of the authorized user of the electronic device to the plurality of user interface elements. At step 204, the method 200 determines, from the reactions, a user sensory preference reaction score.

In one or more embodiments, the user sensory preference reaction score is determined using an eye-minded dominance score, a smell-minded dominance score, an ear-minded dominance score, a taste-minded dominance score, and a motor-minded dominance score, as noted above. In one or more embodiments, each of the eye-minded dominance score, the smell-minded dominance score, the ear-minded dominance score, the taste-minded dominance score, and the motor-minded dominance score is normalized at step 204 to have a value of between one and negative one, inclusive.

In one or more embodiments, the user sensory preference reaction score determined at step 204 is also associated with a dominant sensory profile associated with the authorized user of the electronic device. At step 205, one or both of the user sensory preference reaction score and/or dominant sensory profile can be stored in a memory of the electronic device with a user profile belonging to the authorized user of the electronic device.

Step 206 then repeats the method 200 each time a different user is detected using the electronic device. Accordingly, in one or more embodiments step 206 comprises one or more sensors detecting another user using the electronic device, repeating the presentation of step 202, measuring other reactions similar to step 203, and determining another user sensory preference reaction score as in step 204. Step 206 can then comprise associating the other user sensory preference reaction score with another display associated with the other user and storing that dominant sensory profile and/or user sensory preference reaction score in the memory as in step 205.

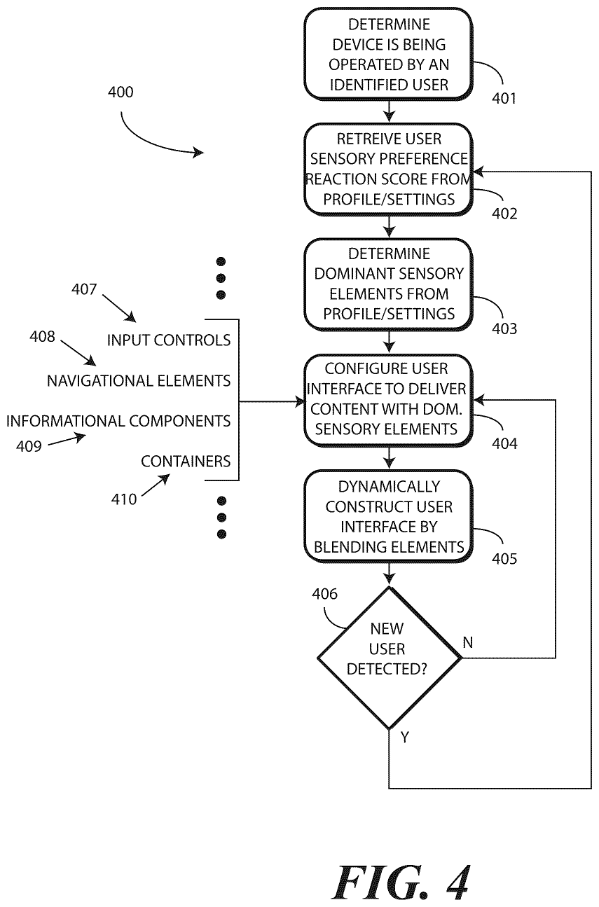

Turning now to FIG. 4, illustrated therein is a method 400 of modifying user interface elements once the user sensory preference reaction score has been calculated using any of the methods described above with reference to FIGS. 1-2. While those methods determined the user sensory preference reaction score, and optionally the dominant sensory profile, the method 400 of FIG. 4 uses these elements to modify user interface elements to create modified user interface elements.

Beginning at step 401, one or more sensors of an electronic device identify a particular user operating the electronic device. At step 402, one or more processors of an electronic device retrieve the user sensory preference reaction score, or dominant sensory profile associated with that user from a memory orientation detector the electronic device. At step 403, the one or more processors determine to which sensory perceptions user interface elements should cater for that particular user from the user sensory preference reaction score or dominant sensory profile.

At step 404, the one or more processors of the electronic device modify one or more user interface elements, which can be any of input controls 407, navigational elements 408, informational components 409, or containers 410, that are configured for presentation on the user interface of the electronic device. In one or more embodiments, step 404 makes this modification as a function of the user sensory preference reaction score or dominant sensory profile to create one or more modified user interface elements.

At step 405, the one or more processors dynamically construct a user interface presentation by blending the elements such that some elements are enhanced, and some other elements are diminished. Illustrating by example, step 405 can result in the one or more modified user interface elements being enhanced as a function of a first combination of a visual appearance preferred by the authorized user of the electronic device, an olfactory appearance preferred by the authorized user of the electronic device, an aural appearance preferred by the authorized user of the electronic device, a gustatory appearance preferred by the authorized user of the electronic device, and a haptic appearance preferred by the authorized user of the electronic device and diminished as a second combination of the visual appearance preferred by the authorized user of the electronic device, the olfactory appearance preferred by the authorized user of the electronic device, the aural appearance preferred by the authorized user of the electronic device, the gustatory appearance preferred by the authorized user of the electronic device, and the haptic appearance preferred by the authorized user of the electronic device, and so forth. The resulting user interface presentation can then be presented to a user. When decision 406 determines that a new user is using the electronic device, the method 400 can repeat.

Turning now again to FIG. 3, illustrated therein is a system flow diagram showing how a plurality of user interface elements 301,302,303 can be modified in accordance with the method (400) of FIG. 4. Beginning at step 402, in response to one or more sensors of an electronic device determining the identity of a user of an electronic device, step 402 comprises determining a dominant sensory profile associated with a user of the electronic device. In one or more embodiments, step 402 comprises retrieving, by one or more processors of the electronic device, a user sensory preference reaction score 118 from a user profile stored in the memory of the electronic device.

In one or more embodiments, the user sensory preference reaction score 118 comprises a plurality of user sensory preference elements. In the illustrative embodiment of FIG. 3, the plurality of user sensory preference elements comprises an eye-minded dominance score 308, a smell-minded dominance score 309, an ear-minded dominance score 310, a taste-minded dominance score 311, and a motor-minded dominance score 312. In one or more embodiments, these user sensory preference elements are normalized to have a value of between one and minus one, inclusive. Step 403 the comprises determining which sensory preference elements are dominant to s user.

Step 404 the comprises modifying, by one or more processors of the electronic device, one or more user interface elements 301,302,303 each having user sensory preference elements 304,305,306 catering to senses as a function of the dominant sensory profile defined by the user sensory preference reaction score 118 to create one or more modified user interface elements 313,314,315 that cater to the user's preferred sensory perceptions. Step 405 can then dynamically construct a user interface using the one or more modified user interface elements 313,314,315 so that the one or more modified user interface elements 313,314,315 can be presented on a user interface as previously described.

Thus, as graphically illustrated in FIG. 3, in one or more embodiments a method comprises determining, by one or more processors of an electronic device, a display associated with a user of the electronic device. The method then comprises one or more processors modifying one or more user interface elements 301,302,303 as a function of the dominant sensory profile associated with the user of the electronic device to create one or more modified user interface elements 313,314,315. The one or more processors modified user interface elements 313,314,315 can then be presented on a user interface of the electronic device.

Prior to this, a method can comprise presenting, by one or more processors on a user interface, another plurality of user interface elements, where each user interface element of the plurality of user interface elements includes components catering to different sensory perceptions from other user interface elements of the plurality of user interface elements. The method then comprises measuring, by one or more sensors, reactions of a user of the electronic device to the plurality of user interface elements. The method determines, by the one or more processors from the reactions, a user sensory preference reaction score 118. The method then stores the user sensory preference reaction score 118 in a memory of the electronic device. When combined with the feature described above with reference to FIG. 10, the method can also adjust, by the one or more processors, the user sensory preference reaction score 118 in response to user input received at the user interface.

Turning now to FIG. 11, illustrated therein are various embodiments of the disclosure. The embodiments of FIG. 11 are shown as labeled boxes in FIG. 11 due to the fact that the individual components of these embodiments have been illustrated in detail in FIGS. 1-10, which precede FIG. 11. Accordingly, since these items have previously been illustrated and described, their repeated illustration is no longer essential for a proper understanding of these embodiments. Thus, the embodiments are shown as labeled boxes.

At 1101, a method in an electronic device comprises identifying, by one or more sensors of the electronic device, a user using the electronic device. At 1101, the method comprises determining, by one or more processors of the electronic device, a dominant sensory profile associated with the user of the electronic device.

At 1101, the method comprises modifying, by the one or more processors, one or more user interface elements configured for presentation on a user interface of the electronic device as a function of the dominant sensory profile associated with the user of the electronic device to create a one or more modified user interface elements. At 1101, the method comprises presenting, by the one or more processors on the user interface of the electronic device, the one or more modified user interface elements.

At 1102, the determining the dominant sensory profile of 1101 associated with the user of the electronic device comprises retrieving, by the one or more processors, a user sensory preference reaction score from a user profile stored in a memory of the electronic device. At 1103, the method of 1102 further comprises presenting, by the one or more processors, the user sensory preference reaction score from the user profile on the user interface. At 1103, the method comprises receiving, by the user interface, user input in response to the presenting. At 1103, the method comprises adjusting one or more sensory preference elements of the user sensory preference reaction score as a function of the user input.

At 1104, the one or more sensory preference elements of 1103 comprise a plurality of user sensory preference elements. At 1105, the plurality of user sensory preference elements comprises an eye-minded dominance score, a smell-minded dominance score, an ear-minded dominance score, a taste-minded dominance score, and a motor-minded dominance score.

At 1106, the one or more user interface elements of 1105 configured for presentation on the user interface of the electronic device comprise one or more of user input controls, navigational elements, and/or containers. At 1107, the one or more user interface elements of 1105 configured for presentation on the user interface of the electronic device comprise informational components comprising text. At 1107, the modifying the one or more user interface elements to create the one or more modified user interface elements comprises changing the text to enhance a characteristic associated with at least one user sensory preference element and diminish another characteristic associated with at least one other user sensory preference element.

At 1108, each of the eye-minded dominance score, the smell-minded dominance score, the ear-minded dominance score, the taste-minded dominance score, and the motor-minded dominance score of 1105 is normalized to have a value between one and negative one, inclusive.

At 1109, the method of 1108 further comprises, prior to the determining, presenting, by the one or more processors on the user interface, a plurality of user interface elements. At 1109, each user interface element of the plurality of user interface elements includes components catering to different sensory perceptions from other user interface elements of the plurality of user interface elements.

At 1110, the method of 1109 further comprises measuring, by one or more sensors, reactions of the user of the electronic device to the plurality of user interface elements. At 1110, the method comprises determining, by the one or more processors from the reactions, the user sensory preference reaction score. At 1111, the method of 1110 further comprises, when the one or more sensors detect another user using the electronic device, repeating the presenting the plurality of user interface elements, measuring other reactions of the another user of the electronic device to the plurality of user interface elements, and determining, by the one or more processors from the other reactions, another user sensory preference reaction score.

At 1112, an electronic device comprises a user interface and one or more processors operable with the user interface. At 1112, the one or more processors are configured to modify one or more user interface elements as a function of a dominant sensory profile associated with an authorized user of the electronic device to create a one or more modified user interface elements and, thereafter, cause the user interface to present the one or more modified user interface elements.

At 1113, the one or more modified user interface elements of 1112 are enhanced as a function of a first combination of a visual appearance preferred by the authorized user of the electronic device, an olfactory appearance preferred by the authorized user of the electronic device, an aural appearance preferred by the authorized user of the electronic device, a gustatory appearance preferred by the authorized user of the electronic device, and a haptic appearance preferred by the authorized user of the electronic device and diminished as a second combination of the visual appearance preferred by the authorized user of the electronic device, the olfactory appearance preferred by the authorized user of the electronic device, the aural appearance preferred by the authorized user of the electronic device, the gustatory appearance preferred by the authorized user of the electronic device, and the haptic appearance preferred by the authorized user of the electronic device.

At 1114, the one or more modified user interface elements of 1113 comprise text that is different from the one or more user interface elements. At 1115, t heeled of 1113 further comprises one or more sensors. At 1113, the one or more sensors are configured to identify the authorized user of the electronic device when the authorized user is using the electronic device and the dominant sensory profile associated with the authorized user is stored in a user profile of the authorized user of the electronic device.

At 1116, the one or more processors of 1115 are configured to cease presenting the one or more modified user interface elements when the one or more sensors detect a user other than the authorized user using the electronic device. At 1117, the one or more processors of 1115 are configured to modify the one or more modified user interface elements to create other modified user interface elements in response to user input received by the user interface modifying the dominant sensory profile associated with the authorized user of the electronic device.

At 1118, a method for an electronic device comprises presenting, by one or more processors on a user interface, a plurality of user interface elements. At 1118, each user interface element of the plurality of user interface elements includes components catering to different sensory perceptions from other user interface elements of the plurality of user interface elements.

At 1118, the method comprises measuring, by one or more sensors, reactions of a user of the electronic device to the plurality of user interface elements and determining, by the one or more processors from the reactions, a user sensory preference reaction score. Thereafter, the method of 1118 comprises modifying, by the one or more processors, one or more other user interface elements configured for presentation on the user interface as a function of the user sensory preference reaction score to create a one or more modified user interface elements and presenting, by the one or more processors on the user interface, the one or more modified user interface elements.

At 1119, the presenting of 1118 occurs only as long as the user is using the electronic device. At 1120, the method of 1119 further comprises adjusting, by the one or more processors, the user sensory preference reaction score in response to user input received at the user interface.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Consider an example. Imagine that a clothing company called “Fashion Brand Kick” is in the process of transformation, as they want to be seen as catering to the young. As part of the exercise, they want to change the user interface of their online store. In doing so, the new user interface reflects what they believe their brand stands for, namely, bright colors, lots of motion, funky music playing in the background, and so forth.

Now imagine that Elizabeth is the mother of teenagers that are a fan of the brand. Her children love the clothes from Kick. Imagine that it is summer, and Elizabeth navigates a web browser of her electronic device to the user interface of the online store. She notices the changed user interface, which does not seem too different from a navigation perspective. However, as she traverses the user interface, she feels discomfort due to the fact that too much seems to be happening.

In a quest to reflect their brand, the online store has caused sensory overload that Elizabeth is unable to handle. She eventually gives up. Her children are bewildered as to why. They seem to love the experience.

The problem is that one such user interface does not fit all. Unfortunately, until the present disclosure, prior art devices provided no way to customize such a user interface based upon the sensory preferences of each individual user. Advantageously, embodiments of the disclosure not only measure a user sensory preference reaction score, and optionally a dominant sensory profile, by which user interface elements can be modified to personally tailor content offerings to the sensory perceptions preferred by a user.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
identifying, by one or more sensors of the electronic device, a user using the electronic device;
determining, by one or more processors of the electronic device, a dominant sensory profile associated with the user of the electronic device;
modifying, by the one or more processors, one or more user interface elements configured for presentation on a user interface of the electronic device as a function of the dominant sensory profile associated with the user of the electronic device to create a one or more modified user interface elements; and
presenting, by the one or more processors on the user interface of the electronic device, the one or more modified user interface elements.

2. The method of claim 1, wherein the determining the dominant sensory profile associated with the user of the electronic device comprises retrieving, by the one or more processors, a user sensory preference reaction score from a user profile stored in a memory of the electronic device.

3. The method of claim 2, further comprising:
presenting, by the one or more processors, the user sensory preference reaction score from the user profile on the user interface;
receiving, by the user interface, user input in response to the presenting; and
adjusting one or more sensory preference elements of the user sensory preference reaction score as a function of the user input.

4. The method of claim 3, wherein the one or more sensory preference elements comprise a plurality of user sensory preference elements.

5. The method of claim 4, wherein the plurality of user sensory preference elements comprises:
an eye-minded dominance score;
a smell-minded dominance score;
an ear-minded dominance score;
a taste-minded dominance score; and
a motor-minded dominance score.

6. The method of claim 5, wherein the one or more user interface elements configured for presentation on the user interface of the electronic device comprise one or more of:
user input controls;
navigational elements; and/or
containers.

7. The method of claim 5, wherein:
the one or more user interface elements configured for presentation on the user interface of the electronic device comprise informational components comprising text; and
the modifying the one or more user interface elements to create the one or more modified user interface elements comprises changing the text to enhance a characteristic associated with at least one user sensory preference element and diminish another characteristic associated with at least one other user sensory preference element.

8. The method of claim 5, wherein each of the eye-minded dominance score, the smell-minded dominance score, the ear-minded dominance score, the taste-minded dominance score, and the motor-minded dominance score is normalized to have a value between one and negative one, inclusive.

9. The method of claim 8, further comprising, prior to the determining:
presenting, by the one or more processors on the user interface, a plurality of user interface elements;
wherein each user interface element of the plurality of user interface elements includes components catering to different sensory perceptions from other user interface elements of the plurality of user interface elements.

10. The method of claim 9, further comprising:
measuring, by one or more sensors, reactions of the user of the electronic device to the plurality of user interface elements; and
determining, by the one or more processors from the reactions, the user sensory preference reaction score.

11. The method of claim 10, further comprising, when the one or more sensors detect another user using the electronic device:
repeating the presenting the plurality of user interface elements;
measuring other reactions of the another user of the electronic device to the plurality of user interface elements; and
determining, by the one or more processors from the other reactions, another user sensory preference reaction score.

12. An electronic device, comprising:
a user interface; and
one or more processors operable with the user interface;
wherein the one or more processors are configured to modify one or more user interface elements as a function of a dominant sensory profile associated with an authorized user of the electronic device to create a one or more modified user interface elements and, thereafter, cause the user interface to present the one or more modified user interface elements.

13. The electronic device of claim 12, wherein the one or more modified user interface elements are enhanced as a function of a first combination of a visual appearance preferred by the authorized user of the electronic device, an olfactory appearance preferred by the authorized user of the electronic device, an aural appearance preferred by the authorized user of the electronic device, a gustatory appearance preferred by the authorized user of the electronic device, and a haptic appearance preferred by the authorized user of the electronic device and diminished as a second combination of the visual appearance preferred by the authorized user of the electronic device, the olfactory appearance preferred by the authorized user of the electronic device, the aural appearance preferred by the authorized user of the electronic device, the gustatory appearance preferred by the authorized user of the electronic device, and the haptic appearance preferred by the authorized user of the electronic device.

14. The electronic device of claim 13, wherein the one or more modified user interface elements comprise text that is different from the one or more user interface elements.

15. The electronic device of claim 13, further comprising one or more sensors, wherein:
the one or more sensors are configured to identify the authorized user of the electronic device when the authorized user is using the electronic device; and
the dominant sensory profile associated with the authorized user is stored in a user profile of the authorized user of the electronic device.

16. The electronic device of claim 15, wherein the one or more processors are configured to cease presenting the one or more modified user interface elements when the one or more sensors detect a user other than the authorized user using the electronic device.

17. The electronic device of claim 15, wherein the one or more processors are configured to modify the one or more modified user interface elements to create other modified user interface elements in response to user input received by the user interface modifying the dominant sensory profile associated with the authorized user of the electronic device.

18. A method for an electronic device, the method comprising:
presenting, by one or more processors on a user interface, a plurality of user interface elements, wherein each user interface element of the plurality of user interface elements includes components catering to different sensory perceptions from other user interface elements of the plurality of user interface elements;
measuring, by one or more sensors, reactions of a user of the electronic device to the plurality of user interface elements;
determining, by the one or more processors from the reactions, a user sensory preference reaction score; and
thereafter, modifying, by the one or more processors, one or more other user interface elements configured for presentation on the user interface as a function of the user sensory preference reaction score to create a one or more modified user interface elements; and
presenting, by the one or more processors on the user interface, the one or more modified user interface elements.

19. The method of claim 18, wherein the presenting occurs only as long as the user is using the electronic device.

20. The method of claim 19, further comprising adjusting, by the one or more processors, the user sensory preference reaction score in response to user input received at the user interface.
